(19) United States
(12) Patent Application Publication
(10) Pub. No.: US 2025/0208651 A1
(43) Pub. Date: Jun. 26, 2025

(54) FOLDABLE COMPUTING DEVICE

(71) Applicant: SAMSUNG ELECTRONICS CO., LTD., Suwon-si (KR)

(72) Inventor: Xiang Gu, Jiangsu (CN)

(73) Assignee: SAMSUNG ELECTRONICS CO., LTD., Suwon-si (KR)

(21) Appl. No.: 19/074,021

(22) Filed: Mar. 7, 2025

Related U.S. Application Data
(63) Continuation of application No. PCT/KR2023/005018, filed on Apr. 13, 2023.

(30) Foreign Application Priority Data
Sep. 9, 2022 (CN) 202211102442.8

(51) Int. Cl. G06F 1/16

(52) U.S. Cl. CPC G06F 1/1616

(57) ABSTRACT

A foldable computing device includes a first body including a bottom case including an interface opening, a daughter board, and an input/output (IO) port on the daughter board and corresponding to the interface opening. The foldable computing device further includes: a rotating shaft; a second body pivotally connected to the first body by the rotating shaft; and a telescoping unit including at least one body that is connected to the rotating shaft, wherein the rotating shaft is configured to rotate based on unfolding or folding of the first body and the second body with respect to each other, and wherein the at least one body of the telescoping unit is configured to cause the IO port to telescopically engage with or disengage from the interface opening based on the rotating shaft rotating due to the unfolding or the folding.

### CROSS-REFERENCE TO RELATED APPLICATIONS

This application is a bypass continuation application of International Application No. PCT/KR2023/005018, filed on Apr. 13, 2023, which claims priority to Chinese Patent Application No. 202211102442.8, filed on Sep. 9, 2022, in the China National Intellectual Property Administration, the contents of which are herein incorporated by reference in their entireties.

### BACKGROUND

### 1. Field

Embodiments of the present disclosure relate to a computing device and, in particular, to a foldable computing device with input/output (IO) ports.

### 2. Description of Related Art

Notebook computers generally have one or more interface slots on a backside or lateral sides thereof to couple with connectors of different peripheral devices. When the interface slot is not in use, a lid to prevent external dust from smearing the interface slot usually covers it. There are many types of lid mechanisms to cover the interface slot and provide a dust-guarding function, such as a lid having a latch structure for a conventional notebook computer. When in use, the latch structure may be pushed to unlatch a computer case, and the lid may be turned outwards to expose the interface slot. When not in use, the lid may be swung about stub shafts to cover the interface slot and the latch structure may be moved to latch on the computer case. Such a structure is complicated and includes many delicate elements such as springs. The structure is not sturdy and cannot withstand a strong impact of external forces. Damage or dislocation of the springs often occurs. The structure does not have much shock absorption capability. Moreover, such a structure uses a sliding mechanism that cannot prevent moisture from seeping into the interface slot when closed. Hence, the structure also cannot provide a satisfactory waterproof function.

### SUMMARY

According to a comparative embodiment, a lid structure for the interface slot of notebook computers has a lid located on an input/output interface opening on one side of the computer case. When the interface slot is not in use, the lid is turned about a pintle and bulged elements located on L-shape plates of the lid are moved to couple with latch cavities formed on two sides of the interface slot in a latched position. On the contrary, the lid is opened when pulled forcefully. While the lid structure of the comparative embodiment provides some degree of dust-guarding, it does not help much in the waterproof and shock-absorption functions.

Some embodiments of the present disclosure provide a foldable computing device with a telescoping unit having a simple and easy-to-use structure.

According to embodiments of the present disclosure, a foldable computing device may be provided and include a first body including a bottom case including an interface opening, a daughter board, and an input/output (IO) port on the daughter board and corresponding to the interface opening. The foldable computing device may further include: a rotating shaft; a second body pivotally connected to the first body by the rotating shaft; and a telescoping unit including at least one body that is connected to the rotating shaft, wherein the rotating shaft is configured to rotate based on unfolding or folding of the first body and the second body with respect to each other, and wherein the at least one body of the telescoping unit is configured to cause the IO port to telescopically engage with or disengage from the interface opening based on the rotating shaft rotating due to the unfolding or the folding.

According to one or more embodiments of the present disclosure, the at least one body of the telescoping unit is further configured to: cause the IO port on the daughter board to retract inside the interface opening based on the rotating shaft rotating due to the folding of the first body and the second body with respect to each other; and cause the IO port on the daughter board to protrude from the interface opening based on the rotating shaft rotating due to the unfolding of the first body and the second body with respect to each other.

According to one or more embodiments of the present disclosure, the at least one body of the telescoping unit includes a first slider and a drive link, wherein the first slider is movably arranged on the bottom case, and the daughter board is fixed on the first slider, wherein the drive link includes a first end connected to the rotating shaft, a second end opposite to the first end and connected to the first slider, and a rotating part between the first end and the second end, wherein the drive link is rotatably arranged on the bottom case by the rotating part, wherein the rotating shaft is configured to, by rotating, rotate the first end of the drive link such that the second end of the drive link rotates and pushes the first slider, and wherein the first slider is configured to, based on the first slider being pushed by the second end of the drive link, cause the IO port on the daughter board to telescopically engage with or disengage from the interface opening.

According to one or more embodiments of the present disclosure, an outer surface of the rotating shaft includes: a first guide groove extending along an axial direction of the rotating shaft; and a second guide groove communicating with the first guide groove and extending along a circumferential direction of the rotating shaft, and wherein the first end of the drive link is movably arranged inside the first guide groove and the second guide groove such that the first end of the drive link is configured to be driven by the rotating shaft to rotate around the rotating part.

According to one or more embodiments of the present disclosure, the foldable computing device further includes a first guide rail on the bottom case, wherein the first slider is movably disposed on the first guide rail.

According to one or more embodiments of the present disclosure, the first guide rail includes a first receiving slot configured to receive the first slider.

According to one or more embodiments of the present disclosure, the second end of the drive link includes a gear portion including tines arranged along a sliding direction of the first slider, and wherein the first slider includes a rack portion configured to engage with the gear portion of the drive link on a side surface of the first slider adjacent to the drive link.

According to one or more embodiments of the present disclosure, the foldable computing device further includes: a second guide rail on the bottom case and in parallel with the first guide rail; and a second slider movably disposed on the second guide rail, wherein the daughter board is fixed on the second slider.

According to one or more embodiments of the present disclosure, the second guide rail includes a second receiving slot that is configured to receive the second slider.

According to one or more embodiments of the present disclosure, each of the first guide rail and the second guide rail include a first screw hole, and the first guide rail and the second guide rail are fixed on the bottom case via the first screw hole, and wherein each of the first slider and the second slider include a second screw hole, and the first slider and the second slider are fixed on the daughter board via the second screw hole.

According to one or more embodiments of the present disclosure, the foldable computing device further includes: a flexible printed circuit; and a mother board on the bottom case, wherein the daughter board is electrically connected to the mother board by the flexible printed circuit.

According to one or more embodiments of the present disclosure, the foldable computing device is a laptop computer.

According to one or more embodiments of the present disclosure, the foldable computing device is a foldable phone.

According to embodiments of the present disclosure, a foldable computing device may be provided and include a first body including a first case including an interface opening, and an input/output (IO) port corresponding to the interface opening. The foldable computing device may further include a rotating shaft; a second body pivotally connected to the first body by the rotating shaft; and a telescoping unit including at least one body that is connected to the rotating shaft, wherein the rotating shaft is configured to rotate based on unfolding or folding of the first body and the second body with respect to each other, and wherein the at least one body of the telescoping unit is configured to cause the IO port to telescopically engage with or disengage from the interface opening based on the rotating shaft rotating due to the unfolding or the folding.

According to one or more embodiments of the present disclosure, the at least one body of the telescoping unit is further configured to: cause the IO port to retract inside the interface opening based on the rotating shaft rotating due to the folding of the first body and the second body with respect to each other; and cause the IO port to protrude from the interface opening based on the rotating shaft rotating due to the unfolding of the first body and the second body with respect to each other.

According to one or more embodiments of the present disclosure, the at least one body of the telescoping unit includes a first slider and a drive link, wherein the rotating shaft is configured to, by rotating, rotate the drive link such that the drive link pushes the first slider, and wherein the first slider is configured to, based on the first slider being pushed by the drive link, cause the IO port to telescopically engage with or disengage from the interface opening.

According to embodiments of the present disclosure, a method may be provided and include: causing a rotating shaft of a foldable computing device to rotate by unfolding or folding a first body and a second body of the foldable computing device with respect to each other; and causing an input/output (IO) port of the first body to telescopically engage with or disengage from an interface opening of the first body based on rotation of the rotating shaft.

According to one or more embodiments of the present disclosure, the causing the IO port includes causing the IO port to retract inside the interface opening based on the rotating shaft rotating due to the folding of the first body and the second body with respect to each other.

According to one or more embodiments of the present disclosure, the causing the IO port includes causing the IO port to protrude from the interface opening based on the rotating shaft rotating due to the unfolding of the first body and the second body with respect to each other.

According to one or more embodiments of the present disclosure, the first body includes a daughter board that includes the IO port, and wherein the causing the IO port includes causing the daughter board to move based on the rotation of the rotating shaft.

According to some embodiments of the present disclosure, the telescoping unit may drive the IO port on a daughter board, wherein the IO port may be telescopically engageable with the interface opening based on the first body and the second body folding or unfolding due to rotation of the rotating shaft. The telescoping unit may have a simple and easy-to-use structure, providing a product of novelty and integrality.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a first schematic view showing a foldable computing device according to an example embodiment of the present disclosure.

FIG. 2 is a second schematic view showing the foldable computing device according to an example embodiment of the present disclosure.

FIG. 3 is a schematic view showing a rotating shaft of the foldable computing device according to an example embodiment of the present disclosure.

FIG. 4 is a schematic view showing a working principle of the foldable computing device according to an example embodiment of the present disclosure.

FIG. 5 is a third schematic view showing the foldable computing device according to an example embodiment of the present disclosure.

FIG. 6 is a first schematic view showing an effect of the foldable computing device according to an example embodiment of the present disclosure.

FIG. 7 is a second schematic view showing an effect of the foldable computing device according to an example embodiment of the present disclosure.

### DETAILED DESCRIPTION

To sufficiently describe configurations and effects of the present disclosure, non-limiting example embodiments of the present disclosure will be described with reference to the accompanying drawings. However, embodiments of the present disclosure are not limited to the example embodiments to be described below, and may be implemented in several forms and may be variously modified. Description of these example embodiments will be provided to make the present disclosure complete and allow those skilled in the art to which the present disclosure pertains to completely recognize the scope of the present disclosure. In the accompanying drawings, sizes of components may be enlarged as compared with actual sizes for convenience of explanation, and ratios of the respective components may be exaggerated or reduced.

Terms “first,” “second,” and the like, may be used to describe various components, but the components are not to be limited by the terms. These terms may be used to differentiate one component from other components. For example, a “first connecting component” may be called a “second connecting component,” and the “second connecting component” may also be called the “first connecting component.”

Singular forms are intended to include plural forms unless the context clearly indicates otherwise. It may be interpreted that the terms “include,” “have,” “comprise,” or the like, specify the presence of features, shapes, steps, operations, components, parts mentioned in the specification, or a combination thereof, but do not preclude the addition of one or more other features, shapes, steps, operations, components, parts, or a combination thereof.

Terms used in examples of the present disclosure may be interpreted to have the same meanings as meanings that are generally known to those skilled in the art unless defined otherwise. Hereinafter, non-limiting example embodiments of the present disclosure will be described in detail with reference to the accompanying drawings.

It will be understood that when an element or layer is referred to as being “on,” “connected to,” or “coupled to” another element or layer, it can be directly on, connected to, or coupled to the other element or layer or intervening elements or layers may be present. In contrast, when an element or layer is referred to as being “directly on,” “directly connected to,” or “directly coupled to” another element or layer, there are no intervening elements or layers present.

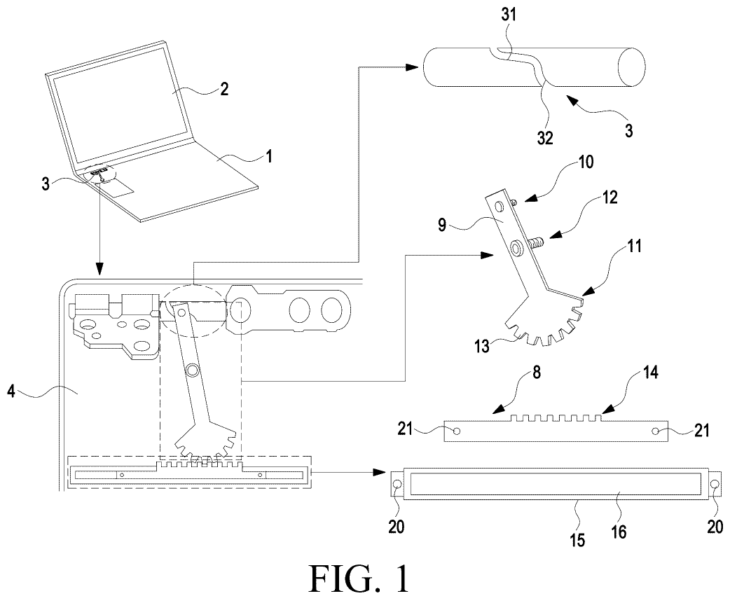

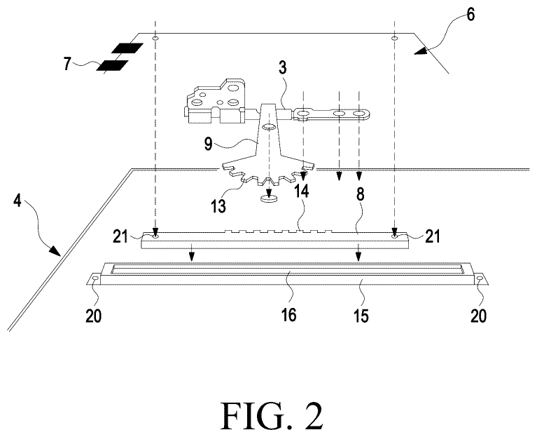

FIG. 1 is a first schematic view showing a foldable computing device according to an example embodiment of the present disclosure. FIG. 2 is a second schematic view showing the foldable computing device according to an example embodiment of the present disclosure. It should be understood that, although the description takes the notebook computer as an example, the foldable computing device in embodiments of the present disclosure can also be other electronic equipment such as a foldable phone. The foldable computing device may comprise a first body 1, a second body 2 pivotally connected with the first body 1 by a rotating shaft 3, and a telescoping unit.

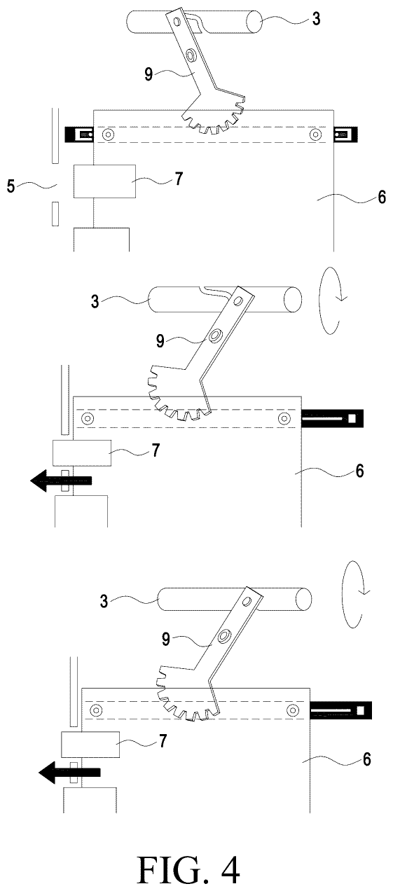

The first body 1 may have a bottom case 4 provided with at least one interface opening 5 (see FIG. 4), and at least one daughter board 6, that is movable, provided with at least one IO port 7 corresponding to the interface opening 5. The IO port 7 may be a universal serial bus (USB) port, RJ11 port, RJ45 port, parallel port, video graphics array (VGA) port, IEEE1394 port, video output port (S terminal), Sony/Philips digital interface format (S/PDIF) port (e.g., for optical fiber output), audio device (e.g., a linear input jack, earphone output jack, microphone input jack), power supply input jack, SD card interface, Personal Computer Memory Card International Association (PCMCIA) interface, or the like. The telescoping unit may be connected with a rotating shaft 3 in a transmission way for driving the IO port 7 on the daughter board 6 to telescopically engage with or disengage from the interface opening 5 based on rotation of the rotating shaft 3 due to the first body 1 and the second body 2 folding or unfolding.

The telescoping unit may include a first slider 8 and a drive link 9. The first slider 8 may be movably arranged on the bottom case 4, and the daughter board 6 may be fixed on the first slider 8. The drive link 9 may have a first end 10, a second end 11 opposite to the first end 10, and a rotating part 12 between the first end 10 and the second end 11. The drive link 9 may be rotatably arranged on the bottom case 4 via the rotating part 12. The first end 10 may be connected with the rotating shaft 3 in a transmission way, and the second end 11 may be connected with the first slider 8 in a transmission way. The second end 11 of the drive link 9 may be provided with a gear portion 13 having a number of tines arranged along the sliding direction of the first slider 8, and the first slider 8 may have a rack portion 14 engaging with the gear portion 13 of the drive link 9 on a side surface of the first slider 8 adjacent to the drive link 9. When the first end 10 of the drive link 9 is driven to rotate by the rotating shaft 3, the second end 11 of the drive link 9 may rotate such as to push the first slider 8, which may cause the IO port 7 on the daughter board 6 to be driven to telescopically engage with or disengage from the interface opening 5. For example, when the first slider 8 is pushed, the first slider 8 may slide in a sliding direction, thereby moving the daughter board 6 fixed thereon toward or away from the interface opening 5 in the sliding direction. Thus, the IO port 7, provided on the daughter board 6, may move toward or away from the interface opening 5 in the sliding direction for engagement thereto or disengagement therefrom.

The bottom case 4 may be provided with a first guide rail 15 onto which the first slider 8 is movably disposed, and the daughter board 6 may be fixed on the first slider 8. The first guide rail 15 may have a first receiving slot 16 into which the first slider 8 may be placed. The bottom case 4 may be provided with a second guide rail in parallel with the first guide rail 15 onto which a second slider may be movably disposed, and the daughter board 6 may be fixed on the second slider. The second guide rail 18 may have a second receiving slot into which the second slider may be placed.

The first guide rail 15 and the second guide rail may each be provided with at least one first screw hole 20, and the first guide rail 15 and the second guide rail may be fixed on the bottom case 4 via the at least one first screw hole 20 and at least one fixing element (e.g., a screw) therein. The first slider 8 and the second slider may each be provided with at least one second screw hole 21, and the first slider 8 and the second slider may be fixed on the daughter board 6 via the at least one second screw hole 21 and at least one fixing element (e.g., a screw) therein.

According to embodiments of the present disclosure, the second guide rail 17, the second slider 18, and the second receiving slot 19 may be the same as or similar to the first guide rail 15, the first slider 8, and the first receiving slot 16, respectively. Accordingly, a configuration of the second guide rail 17, the second slider 18, and the second receiving slot 19 may be understood from the description and illustration of the first guide rail 15, the first slider 8, and the first receiving slot 16 in the present disclosure.

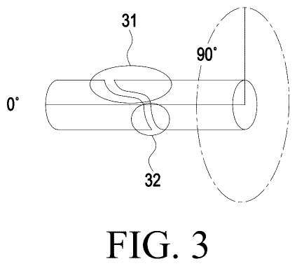

FIG. 3 is a schematic view showing the rotating shaft of the foldable computing device according to an example embodiment of the present disclosure. The outer surface of the rotating shaft 3 may be provided with a first guide groove 31 and a second guide groove 32 communicating with the first guide groove 31. The first end 10 of the drive link 9 may be movably arranged inside the first guide groove 31 and the second guide groove 32 so that the first end 10 of the drive link 9 is driven to rotate around the rotating part 12 by the rotating shaft 3.

FIG. 4 is a schematic view showing a working principle of the foldable computing device according to an example embodiment of the present disclosure. Due to rotation of the rotating shaft 3, the telescoping unit may drive (e.g., move), the IO port 7 on the daughter board 6 to retract inside the interface opening 5 based on at least one from among the first body 1 and the second body 2 rotating (e.g., folding) to a closed position with respect to each other, and, due to rotation of the rotating shaft 3, the telescoping unit may drive (e.g., move), the IO port 7 on the daughter board 6 to protrude from the interface opening 5 based on at least one from among the first body 1 and the second body 2 rotating (e.g., unfolding) to an open position with respect to each other.

The first guide groove 31 may extend substantially along the axial direction of the rotating shaft 3 for guiding the first end 10 of the drive link 9 to rotate to move the IO port 7 telescopically. The second guide groove 32 may extend substantially along the circumferential direction of the rotating shaft 3 for guiding the first end 10 of the drive link 9 to stop rotating to keep the IO port 7 still. As a result, the IO port 7 may be moved outwards (e.g., to or through the interface opening 5) based on the second body 2 opening (e.g., rotating away from the first body 1) with an angle of less than 90 degrees with respect to the first body 1. Based on the second body 2 being rotated to an angle greater than 90 degrees with respect to the first body 1, the IO port 7 may remain still. Conversely, the IO port 7 may remain stay still based on the second body 2 closing (e.g., rotating towards the first body 1) at an angle greater than 90 degrees with respect to the first body 1. The IO port 7 may start retracting into the interface opening 5 based on the second body 2 closing with an angle of less than 90 degrees with respect to the first body 1.

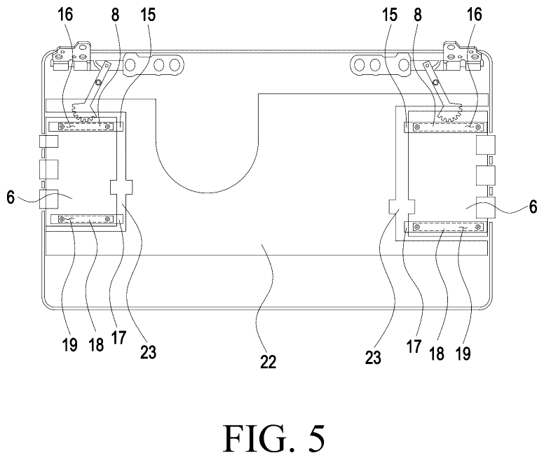

FIG. 5 is a third schematic view showing the foldable computing device according to an example embodiment of the present disclosure. The bottom case 4 may be provided with a mother board 22, and at least one daughter board 6 that is movable and that is electrically connected to the mother board 22 by a flexible printed circuit 23.

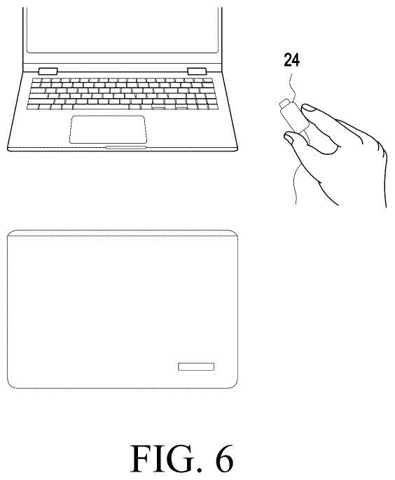

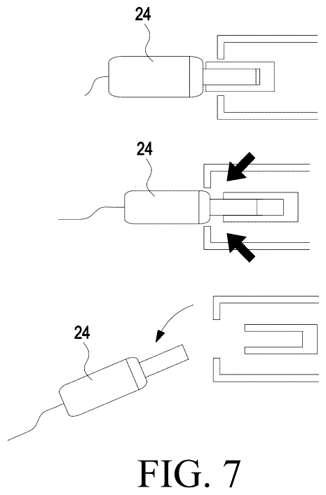

FIG. 6 is a first schematic view showing an effect of the foldable computing device according to an example embodiment of the present disclosure. FIG. 7 is a second schematic view showing an effect of the foldable computing device according to an example embodiment of the present disclosure. Due to rotation of the rotating shaft (e.g., the rotating shaft 3), the telescoping unit may drive the IO port (e.g., the IO port 7) on the daughter board (e.g., the daughter board 6) to telescopically engage with or disengage from the interface opening (e.g., the interface opening 5) based on the first body (e.g., the first body 1) and the second body (e.g., the second body 2) folding or unfolding. Based on the foldable computing device being opened, IO ports (e.g., IO ports 7) on both sides of the foldable computer device may be slightly protruding from the interface openings (e.g., interface openings 5), such that it is easier to confirm the insertion position for connecting with the peripheral equipment. Based on the foldable computing device being closed, the IO ports (e.g., IO ports 7) on both sides may be retracted inside the interface openings (e.g., the interface openings 5) to provide a product appearance of novelty and integrality. A plug 24 of the peripheral equipment can be squeezed out and automatically removed to prevent the IO port from damage.

Although several non-limiting example embodiments of the present disclosure are described above, it can be understood that embodiments of the present disclosure are not limited to the example embodiments, and those skilled in the art can make various changes in form and detail within the spirit and scope of the present disclosure. For example, the connecting device, electronic equipment with the connecting device, and the notebook computer according to the above embodiments of the present disclosure not only can be used as separate solutions, but also can serve as solutions dependent on one another. The present disclosure is intended to cover all of such variations and modifications.

What is claimed is:

1. A foldable computing device comprising:
a first body comprising:
a bottom case including an interface opening;
a daughter board; and
an input/output (IO) port on the daughter board and corresponding to the interface opening;
a rotating shaft;
a second body pivotally connected to the first body by the rotating shaft; and
a telescoping unit comprising at least one body that is connected to the rotating shaft,
wherein the rotating shaft is configured to rotate based on unfolding or folding of the first body and the second body with respect to each other, and
wherein the at least one body of the telescoping unit is configured to cause the IO port to telescopically engage with or disengage from the interface opening based on the rotating shaft rotating due to the unfolding or the folding.

2. The foldable computing device of claim 1, wherein the at least one body of the telescoping unit is further configured to:
cause the IO port on the daughter board to retract inside the interface opening based on the rotating shaft rotating due to the folding of the first body and the second body with respect to each other; and
cause the IO port on the daughter board to protrude from the interface opening based on the rotating shaft rotating due to the unfolding of the first body and the second body with respect to each other.

3. The foldable computing device of claim 1, wherein the at least one body of the telescoping unit comprises a first slider and a drive link,
wherein the first slider is movably arranged on the bottom case, and the daughter board is fixed on the first slider,
wherein the drive link comprises a first end connected to the rotating shaft, a second end opposite to the first end and connected to the first slider, and a rotating part between the first end and the second end,
wherein the drive link is rotatably arranged on the bottom case by the rotating part,
wherein the rotating shaft is configured to, by rotating, rotate the first end of the drive link such that the second end of the drive link rotates and pushes the first slider, and
wherein the first slider is configured to, based on the first slider being pushed by the second end of the drive link, cause the IO port on the daughter board to telescopically engage with or disengage from the interface opening.

4. The foldable computing device of claim 3, wherein an outer surface of the rotating shaft comprises:
a first guide groove extending along an axial direction of the rotating shaft; and
a second guide groove communicating with the first guide groove and extending along a circumferential direction of the rotating shaft, and
wherein the first end of the drive link is movably arranged inside the first guide groove and the second guide groove such that the first end of the drive link is configured to be driven by the rotating shaft to rotate around the rotating part.

5. The foldable computing device of claim 3, further comprising a first guide rail on the bottom case, wherein the first slider is movably disposed on the first guide rail.

6. The foldable computing device of claim 5, wherein the first guide rail comprises a first receiving slot configured to receive the first slider.

7. The foldable computing device of claim 5, wherein the second end of the drive link comprises a gear portion comprising tines arranged along a sliding direction of the first slider, and
wherein the first slider comprises a rack portion configured to engage with the gear portion of the drive link on a side surface of the first slider adjacent to the drive link.

8. The foldable computing device of claim 5, further comprising:
a second guide rail on the bottom case and in parallel with the first guide rail; and
a second slider movably disposed on the second guide rail,
wherein the daughter board is fixed on the second slider.

9. The foldable computing device of claim 8, wherein the second guide rail comprises a second receiving slot that is configured to receive the second slider.

10. The foldable computing device of claim 8, wherein each of the first guide rail and the second guide rail comprises a first screw hole, and the first guide rail and the second guide rail are fixed on the bottom case via the first screw hole, and
wherein each of the first slider and the second slider comprises a second screw hole, and the first slider and the second slider are fixed on the daughter board via the second screw hole.

11. The foldable computing device of claim 1, further comprising:
a flexible printed circuit; and
a mother board on the bottom case,
wherein the daughter board is electrically connected to the mother board by the flexible printed circuit.

12. The foldable computing device of claim 1, wherein the foldable computing device is a laptop computer.

13. The foldable computing device of claim 1, wherein the foldable computing device is a foldable phone.

14. A foldable computing device comprising,
a first body comprising:
a first case comprising an interface opening; and
an input/output (IO) port corresponding to the interface opening;
a rotating shaft;
a second body pivotally connected to the first body by the rotating shaft; and
a telescoping unit comprising at least one body that is connected to the rotating shaft,
wherein the rotating shaft is configured to rotate based on unfolding or folding of the first body and the second body with respect to each other, and
wherein the at least one body of the telescoping unit is configured to cause the IO port to telescopically engage with or disengage from the interface opening based on the rotating shaft rotating due to the unfolding or the folding.

15. The foldable computing device of claim 14, wherein the at least one body of the telescoping unit is further configured to:
cause the IO port to retract inside the interface opening based on the rotating shaft rotating due to the folding of the first body and the second body with respect to each other; and
cause the IO port to protrude from the interface opening based on the rotating shaft rotating due to the unfolding of the first body and the second body with respect to each other.

16. The foldable computing device of claim 14, wherein the at least one body of the telescoping unit comprises a first slider and a drive link,
wherein the rotating shaft is configured to, by rotating, rotate the drive link such that the drive link pushes the first slider, and
wherein the first slider is configured to, based on the first slider being pushed by the drive link, cause the IO port to telescopically engage with or disengage from the interface opening.

17. A method comprising:
causing a rotating shaft of a foldable computing device to rotate by unfolding or folding a first body and a second body of the foldable computing device with respect to each other; and
causing an input/output (IO) port of the first body to telescopically engage with or disengage from an interface opening of the first body based on rotation of the rotating shaft.

18. The method of claim 17, wherein the causing the IO port comprises causing the IO port to retract inside the interface opening based on the rotating shaft rotating due to the folding of the first body and the second body with respect to each other.

19. The method of claim 17, wherein the causing the IO port comprises causing the IO port to protrude from the interface opening based on the rotating shaft rotating due to the unfolding of the first body and the second body with respect to each other.

20. The method of claim 17, wherein the first body comprises a daughter board that comprises the IO port, and
wherein the causing the IO port comprises causing the daughter board to move based on the rotation of the rotating shaft.
